(19) United States
(12) Patent Application Publication
(10) Pub. No.: US 2017/0103722 A1
(43) Pub. Date: Apr. 13, 2017

(54) SHIFT REGISTER UNIT, GATE DRIVING CIRCUIT AND DISPLAY APPARATUS

(71) Applicant: BOE TECHNOLOGY GROUP CO., LTD., Beijing (CN)

(72) Inventors: Chen SONG, Beijing (CN); Zhongyuan WU, Beijing (CN); Kun CAO, Beijing (CN); Hongjun XIE, Beijing (CN)

(21) Appl. No.: 15/122,372

(22) PCT Filed: Aug. 31, 2015
(86) PCT No.: PCT/CN2015/088578

§ 371 Date: Aug. 29, 2016

(30) Foreign Application Priority Data
Mar. 24, 2015 (CN) 201510131787.X

(51) Int. Cl. G09G 3/36

(52) U.S. Cl. CPC G09G 3/3677; G09G 2310/0286; G09G 2310/08; G09G 2330/021

(57) ABSTRACT

The present disclosure provides a shift register unit, a gate driving circuit and a display apparatus. The shift register unit comprises: a first latch module having a first input terminal connected to a first clock signal terminal or a second clock signal terminal, a second input terminal for receiving a pulse signal, and an output terminal; and a second latch module having a first input terminal connected to the first clock signal terminal or the second clock signal terminal, a second input terminal connected to the output terminal of the first latch module, and an output terminal connected to a signal output terminal of the shift register unit. The first input terminal of the first latch module and the first input terminal of the second latch module are connected to the same signal terminal.

The present disclosure claims a benefit from the Chinese Patent Application No. 201510131787.X filed on Mar. 24, 2015, which is incorporated herein by reference.

### TECHNICAL FIELD

The present disclosure relates to a display technology, and more particularly, to a shift register unit, a gate driving circuit and a display apparatus.

### BACKGROUND

Liquid Crystal Displays (LCDs) have been widely applied in electronic devices such as notebook computers, planar TVs or mobile phones, due to their advantages such as low radiation, small size and low energy consumption. An LCD consists of pixel elements arranged in matrices. When the LCD is displaying, a data driving circuit can latch an input display data and a clock signal in a timing order, convert it into an analog signal, and then input it to a data line of an LCD panel. A gate driving circuit can use a shift register unit to convert the input clock signal into a voltage controlling on/off of a pixel and apply it to individual gate lines of the LCD panel.

In order to further reduce the cost of producing an LCD product, a conventional gate driving circuit typically employs a Gate Driver on Array (GOA) design in which a gate switching circuit for a Thin Film Transistor (TFT) is integrated on an array substrate of a display panel as a scanning driver for the display panel. Such gate switching circuit integrated on the array substrate with the GOA technology can also be referred to as a GOA circuit or a shirt register circuit. However, when outputting a scan signal, the conventional GOA circuit needs to apply a charging/discharging control on some nodes in the circuit. If an error occurs in the process of charging/discharging a node, the stability of the GOA circuit will be degraded. For example, a GOA circuit is typically provided with a pull-up node, PU, and a pull-down node, PD. Here, the pull-up node PU is controls a single shift register unit in the GOA circuit to output a scan signal to a corresponding gate line. The pull-down node PD pulls down potentials at an output terminal of the shift register unit and the pull-up node PU, such that the output terminal of the shift register unit will not output any scan signal to the gate line during a non-outputting period. Due to defects in the manufacturing process, there could be some undesirable phenomenon in the TFT on the array substrate, such as current leakage (l_{off}) or threshold voltage (Vth) shift. Therefore, the potential at the pull-down node PD may not be pulled up due to l_{off} or Vth shift, such that the pull-down node PD cannot pull down the potential at the output terminal of the shift register unit. As a result, the shift register unit may erroneously output a scan signal to the corresponding gate line during the non-outputting period, which further degrades the stability of the GOA circuit.

### SUMMARY

The embodiments of the present disclosure provide a shift register unit, a gate driving circuit and a display apparatus.

In an aspect, according to an embodiment of the present disclosure, a shift register unit is provided. The shift register unit comprises: a first latch module having a first input terminal connected to a first clock signal terminal or a second clock signal terminal, a second input terminal for receiving a pulse signal, and an output terminal; and a second latch module having a first input terminal connected to the first clock signal terminal or the second clock signal terminal, a second input terminal connected to the output terminal of the first latch module, and an output terminal connected to a signal output terminal of the shift register unit. The first input terminal of the first latch module and the first input terminal of the second latch module are connected to the same signal terminal.

In another aspect, according to an embodiment of the present disclosure, a gate driving circuit is provided. The gate driving circuit comprises at least two stages of the shift register units according to the above first aspect. In the shift register unit at the first stage, the second input terminal of the first latch module is connected to a pulse signal input terminal. In each of the shift register units except the one at the first stage, the second input terminal of the first latch module is connected to the signal output terminal of the shift register unit at the previous stage. In the shift register unit at each odd-numbered stage, the first input terminal of the first latch module and the first input terminal of the second latch module are connected to the first clock signal terminal, while in the shift register unit at each even-numbered stage, the first input terminal of the first latch module and the first input terminal of the second latch module are connected to the second clock signal terminal.

In yet another aspect, according to an embodiment of the present disclosure, a display apparatus is provided. The display apparatus comprises the gate driving circuit according to the above second aspect.

### BRIEF DESCRIPTION OF THE DRAWINGS

In order to illustrate the solutions according to the embodiments of the present disclosure clearly, the figures used for description of the embodiments will be introduced briefly here. It is apparent to those skilled in the art that the figures described below only illustrate some embodiments of the present disclosure and other figures can be obtained from these figures without applying any inventive skills.

FIG. 1 is a schematic diagram showing a structure of a shift register unit according to an embodiment of the present disclosure;

FIG. 2 is a schematic diagram showing a structure of a latch module in the shift register unit shown in FIG. 1;

FIG. 3 is a schematic diagram showing a structure of a gate driving circuit including cascaded shift register units shown in FIG. 1;

FIG. 4a is a schematic diagram showing a timing sequence for controlling the gate driving circuit shown in FIG. 3;

FIG. 4b is a schematic diagram showing another timing sequence for controlling the gate driving circuit shown in FIG. 3;

FIG. 5 is a schematic diagram showing a structure of a NOR gate in the latch module shown in FIG. 2;

FIG. 6 is a schematic diagram showing another structure of a NOR gate in the latch module shown in FIG. 2; and

FIG. 7 is a schematic diagram showing yet another structure of a NOR gate in the latch module shown in FIG. 2.

### DETAILED DESCRIPTION OF THE EMBODIMENTS

In the following, the solutions according to the embodiments of the present disclosure will be described clearly and fully with reference to the figures. Obviously, the embodiments described below are only some, rather than all, of the embodiments of the present disclosure. Starting from the embodiments of the present disclosure, those skilled in the art can obtain other embodiments without applying any inventive skills. All these embodiments are to be encompassed by the scope of the present disclosure.

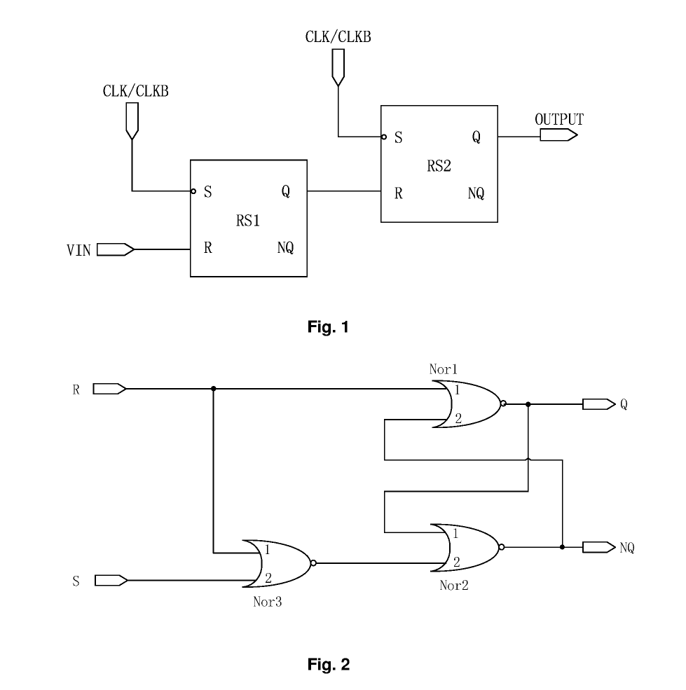

According to an embodiment of the present disclosure, a shift register unit is provided. As shown in FIG. 1, the shift register unit can include a first latch module, RS1, and a second latch module, RS2. Here, each of the first latch module RS1 and the second latch module RS2 can be an RS latch.

In particular, the first latch module RS1 has a first input terminal, S, connected to a first clock signal terminal, CLK, or a second clock signal terminal, CLKB, a second input terminal, R, for receiving a pulse signal, and an output terminal, Q, connected to a second input terminal, R, of the second latch module RS2.

The second latch module RS2 has a first input terminal, S, connected to the first clock signal terminal CLK or the second clock signal terminal CLKB, and an output terminal, Q, connected to a signal output terminal, OUTPUT, of the shift register unit.

The first input terminal S of the first latch module RS1 and the first input terminal S of the second latch module RS2 can be connected to the same signal terminal. That is, the first input terminal S of the first latch module RS1 and the first input terminal S of the second latch module RS2 can both be connected to the first clock signal terminal CLK. Alternatively, the first input terminal S of the first latch module RS1 and the first input terminal S of the second latch module RS2 can both be connected to the second clock signal terminal CLKB.

In addition, the clock signals inputted at the first clock signal terminal CLK and the second clock signal terminal CLKB have the same width but opposite phases.

The embodiment of the present disclosure provides a shift register unit. The shift register unit includes a first latch module and a second latch module. The first latch module has a first input terminal connected to a first clock signal terminal or a second clock signal terminal, a second input terminal for receiving a pulse signal, and an output terminal connected to a second input terminal of the second latch module. The second latch module having a first input terminal connected to the first clock signal terminal or the second clock signal terminal, and an output terminal connected to a signal output terminal of the shift register unit. Further, the first input terminal of the first latch module and the first input terminal of the second latch module are connected to the same signal terminal. According to the above solution, with the first latch module and the second latch module, a single pulse signal inputted at a pulse signal input terminal can be latched and phase-shifted sequentially for each line, such that the sequentially phase-shifted pulse signal can be used as a scan signal for scanning the gate lines of the individual lines sequentially. In particular, the first and second latch modules can each invert and shift the inputted single pulse signal, such that the single pulse signal inputted at the pulse signal input terminal can have the same width as the scan signal received at the gate lines. In a GOA circuit including the first and second latch modules, there is no need to provide any node to be charged/discharged. Thus, any error in charging/discharging such node can be avoided and the stability of the GOA circuit can be improved.

In the following, the above first latch module RS1 and the second latch module RS2 will be explained in detail with reference to the specific embodiments.

### First Embodiment

As shown in FIG. 2, the first latch module RS1 and the second latch module RS2 can include a first NOR gate, nor1, a second NOR gate, nor2, and a third NOR gate, nor3.

Here, the first NOR gate nor1 has a first input terminal, IN1, for receiving the pulse signal (i.e., the first input terminal IN1 of the first NOR gate nor1 can be connected to the second input terminal R of the first latch module RS1 or the second latch module RS2), a second input terminal, IN2, connected to an output terminal of the second NOR gate nor2, and an output terminal connected to the output terminal Q of the first latch module RS1 or the second latch module RS2.

The second NOR gate nor2 has a first input terminal, IN1, connected to the output terminal of the first NOR gate nor2, and a second input terminal, IN2, connected to the output terminal of the third NOR gate.

The third NOR gate nor3 has a first input terminal, IN1, for receiving the pulse signal (i.e., the first input terminal IN1 of the third NOR gate nor3 can be connected to the second input terminal R of the first latch module RS1 or the second latch module RS2), and a second input terminal, IN2, connected to the first second clock signal terminal CLK or the second clock signal terminal CLKB (i.e., the first input terminal IN1 of the third NOR gate nor3 can be connected to the first input terminal S of the first latch module RS1 or the second latch module RS2).

As shown in FIG. 2, the first input terminal IN1 of the above NOR gate (nor1, nor2 or nor3) is represented as 1 and its second input terminal IN2 is represented as 2, for simplicity.

In addition, as shown in FIG. 1 or 2, the first latch module RS1 or the second latch module RS2 has a further output terminal, NQ, in addition to the output terminal Q. When the output terminal Q is used for inputting signals, the output terminal NQ can be floated. Alternatively, the output terminal NQ of the first latch module RS1 or the second latch module RS2 can be used for outputting signals, while the output terminal Q can be floated. In this case, in order to latch a signal, the output terminal NQ of the first latch module RS1 can be connected first to an inverter and then to the second input terminal R of the second latch module. Since the number of elements in the circuit will be increased in such structure, it is preferably to use the output terminal Q for outputting signals, with the output terminal NQ being floated. In the following embodiments, it is assumed as an example that the output terminal Q of the first latch module RS1 or the second latch module RS2 is used for outputting signals, while the output terminal NQ is floated. Therefore, in the following embodiments, the output terminal of each latch module is the output terminal Q.

As described above, the three NOR gates nor1, nor2 and nor3 can be connected to each other to form the first latch module RS1 or the second latch module RS2, and the first latch module RS1 and the second latch module RS2 are connected to each other to form a shift register unit.

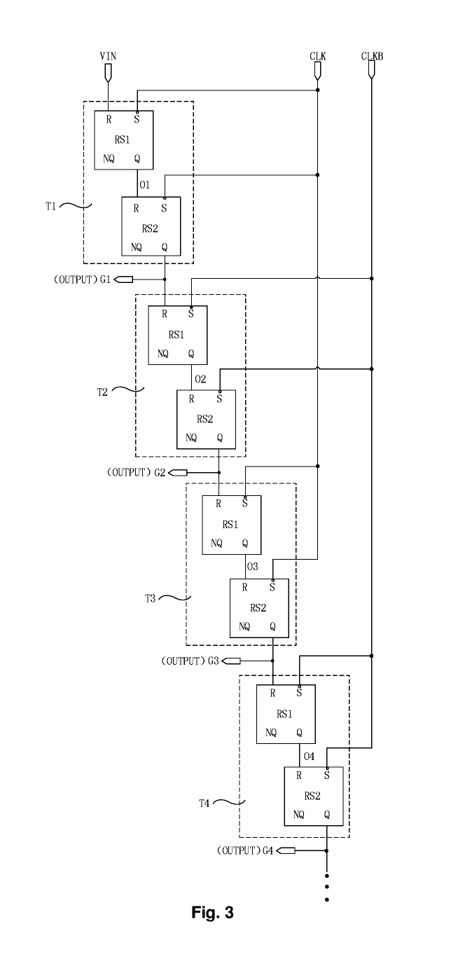

In addition, as shown in FIG. 3, at least two stages of the shift register units as described above can constitute a GOA circuit. Due to the clear and simple logical structure of the NOR gates, the logical structure of the GOA circuit can be simplified. Compared with the conventional GOA circuit, no node requiring charging/discharging control needs to be provided. Further, the input signals to the GOA circuit only include two clock signals (CLK and CLKB) and a pulse signal inputted at a pulse signal input terminal, VIN. Hence, the GOA circuit has simplified input signals. In this way, errors in charging/discharging a node in the conventional GOA circuit due to the complicated circuit structure and the large number of nodes can be avoided, such that the stability of the GOA circuit can be improved.

In particular, as shown in FIG. 3, in the above GOA circuit, the second input terminal R of the first latch module RS1 in the shift register unit, T1, at the first stage is connected to a pulse signal input terminal VIN for inputting a single pulse signal to the gate driving circuit.

In each of the shift register units (T2, T3, . . . , Tn) except T1 at the first stage, the second input terminal R of the first latch module RS1 is connected to the signal output terminal OUTPUT of the shift register unit at the previous stage. For example, the second input terminal R of the first latch module RS1 in the shift register unit T2 is connected to the signal output terminal OUTPUT of the shift register unit T1.

In addition, in the shift register unit (T1, T3, T5, . . . ) at each odd-numbered stage, the first input terminal S of the first latch module RS1 and the first input terminal S of the second latch module RS2 are connected to the first clock signal terminal CLK.

In the shift register unit (T2, T4, T6, . . . ) at each even-numbered stage, the first input terminal S of the first latch module RS1 and the first input terminal S of the second latch module RS2 are connected to the second clock signal terminal CLKB.

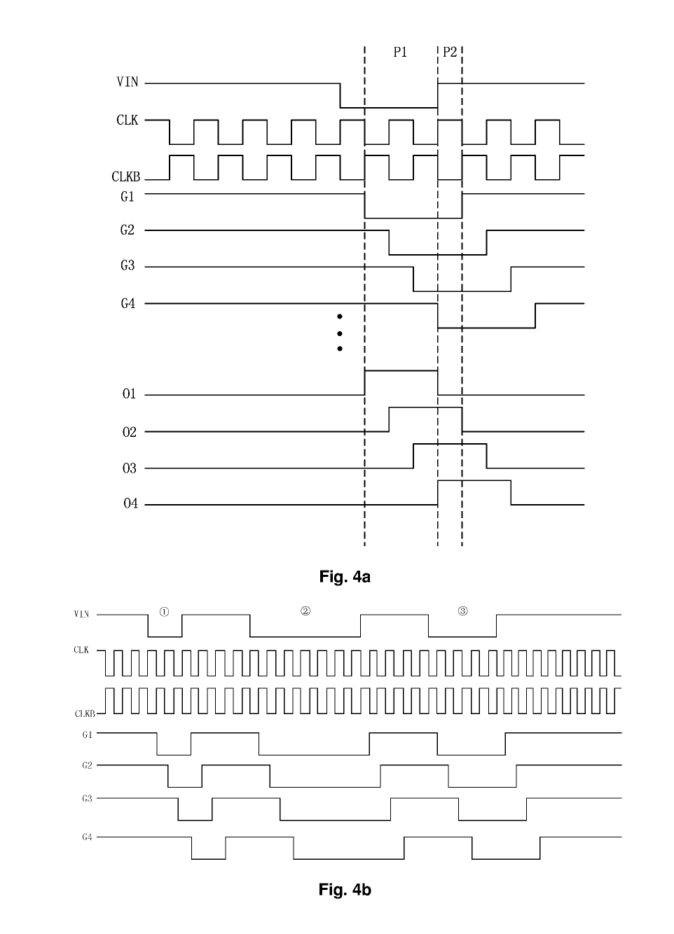

FIG. 4a shows a timing sequence for controlling the above GOA circuit. As shown in FIG. 4a, the GOA circuit consisting of the shift register units (T1, T2, T3, T4, . . . , Tn) according to the embodiment of the present disclosure can shift (or phase-shift) the pulse signal inputted at the pulse signal input terminal VIN for each line, so as to provide scan signals, G1, G2, G3, G4, . . . , for respective gate lines to scan the respective gate lines.

Here, the first latch module RS1 and the second latch module RS2 in each shift register unit each shift and invert the input pulse signal. In particular, in the shift register unit T1 for example, when a pulse signal is inputted to the shift register unit T1 via the second input terminal R of the first latch module RS1, it is latched by the first latch module RS1, such that, in the phase P1 shown in FIG. 4a, the first latch module RS1 can invert and shift the pulse signal inputted at the pulse signal input terminal VIN and an output signal O1 can be outputted the output terminal Q of the first latch module RS1.

Second, in order to let the scan signal G1 received at the gate to have the same width and phase as the pulse signal inputted at the pulse signal input terminal VIN, in the phase P2 shown in FIG. 4a, the signal O1 is inverted and shifted by the second latch module RS2, such that the scan signal G1 that is finally outputted at the signal output terminal OUTPUT of the shift register unit T1 has the same width and phase as the pulse signal inputted at the pulse signal input terminal VIN.

While only the shift register unit T1 has been described above, in each of the other shift register units (T2, T3, T4, . . . , Tn), the principle of outputting the signal (O2, O3, O4, . . . , On) from the output terminal Q of the first latch module RS1 is the same as that of outputting the signal O1 from the output terminal Q of the first latch module RS1 in the shift register unit T1. After the signal (O2, O3, O4, . . . , On) has passed through the second latch module RS2, the principle of outputting the scan signal (G2, G3, G4, . . . , Gn) from the signal output terminal OUTPUT of the shift register unit (T2, T3, T4, . . . , Tn) is the same as that of outputting the scan signal G2 from the signal output terminal OUTPUT of the shift register unit T1. Hence, the details will be omitted here, but are to be encompassed by the scope of the present disclosure.

In particular, the scan signals (G1, G2, G3, G4, . . . , Gn) outputted from the GOA circuit according to the embodiment of the present disclosure to the respective gate lines have the same width and phase as the pulse signal inputted at the pulse signal input terminal VIN. As shown in FIG. 4b, when the width of the pulse signal inputted at the pulse signal input terminal VIN changes (e.g., the width of the pulse signal could be \textcircled{1}, \textcircled{2} or \textcircled{3}), the widths of the scan signals (G1, G2, G3, G4, . . . , Gn) change accordingly, such that the GOA circuit can shift the pulse signal inputted to the GOA circuit and use the shift pulse signals having the same width as the scan signals for scanning the respective gate lines.

Further, in the shift register unit (T1, T3, T5, . . . ) at each odd-numbered stage, the first input terminal S of the first latch module RS1 and the first input terminal S of the second latch module RS2 can be connected to the second clock signal terminal CLKB. In the shift register unit (T2, T4, T6, . . . ) at each even-numbered stage, the first input terminal S of the first latch module RS1 and the first input terminal S of the second latch module RS2 can be connected to the first clock signal terminal CLK.

It can be seen from the operation principle of the gate driving circuit as shown in FIG. 3, in order to enable the gate driving circuit to input the scan signals (G1, G2, G3, . . . ) to the respective gate lines, when the pulse signal inputted from pulse input terminal VIN to the second input terminal R of the first latch module RS1 in the shift register unit T1 at the first stage, the clock signal inputted to the first input terminal S of the first latch module RS1 in the shift register unit T1 at the first stage should be at a high level. However, when the above first input terminal S is connected to the second clock signal CLKB as described above, the second clock signal CLKB is at a low level at this moment. Hence, the second clock signal CLKB needs to be delayed for one square wave, such that it can input the high level to the above first input terminal S, thereby enabling the gate driving circuit to scan the respective gate lines. Thus, the gate driving circuit with the above structure has a lower response speed than the gate driving circuit shown in FIG. 3. Therefore, the structure of the gate driving circuit shown in FIG. 3 is preferable.

The above GOA circuit has the same advantageous effects as the shift register unit according to the above embodiments and details thereof will be omitted here since the structures and advantageous effects of the shift register unit have been described above.

Next, detailed examples will be given with reference to the embodiments, for explaining the NOR gates (nor1, nor2 and nor3) constituting the first latch module RS1 and the second latch module RS2 in the shift register unit (T1, T2, T3, T4, . . . , Tn) at each stage of the above GOA circuit.

### Second Embodiment

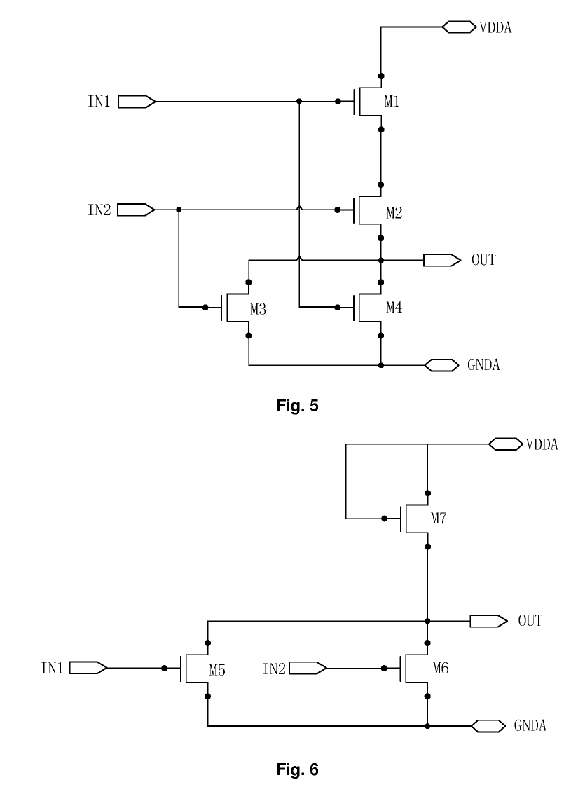

As shown in FIG. 5, the first NOR gate nor1, the second NOR gate nor2, or the third NOR gate nor3 can include a first transistor M1, a second transistor M2, a third transistor M3 and a fourth transistor M4.

The first transistor M1 has a gate connected to the first input terminal IN1 of the NOR gate (nor1, nor2 or nor3), a first electrode connected to a first voltage terminal, VDDA, and a second electrode connected to a first electrode of the second transistor M2.

The second transistor M2 has a gate connected to the second input terminal IN2 of the NOR gate (nor1, nor2 or nor3), and a second electrode connected to the output terminal, OUT, of the NOR gate.

The third transistor M3 has a gate connected to the gate of the second transistor M2, a first electrode connected to the second electrode of the second transistor M2, and a second electrode connected to a second voltage terminal, GNDA.

The fourth transistor M4 has a gate connected to the gate of the first transistor M1, a first electrode connected to the second electrode of the second transistor M2, and a second electrode connected to the second voltage terminal GNDA.

It is to be noted here that each of the first transistor M1 and the second transistor M2 is a P-type transistor, and each of the third transistor M3 and the fourth transistor M4 is an N-type transistor. Here, in the embodiment of the present disclosure, in each transistor, the first electrode can be the source and the second electrode can be the drain. Alternatively, the first electrode can be the drain and the second electrode can be the source. The present disclosure is not limited to any of these.

Further, in the embodiment of the present disclosure, the first voltage terminal VDDA is connected to a high level and the second voltage terminal GNDA is connected to a low level or to the ground, for example.

In this case, when a high level (1) is inputted at the first input terminal IN1 of the NOR gate and a high level (1) is inputted at the second input terminal IN2 of the NOR gate, a low level (0) is outputted at the output terminal of the NOR gate. Similarly, when different signals are inputted at the first input terminal IN1 and the second input terminal IN2, a truth table of the NOR gate (nor1, nor2 or nor3) can be obtained, as shown in Table 1 below:

TABLE 1

| IN1 | IN2 | OUT |
|---|---|---|
| 1 | 1 | 0 |
| 1 | 0 | 0 |
| 0 | 1 | 0 |
| 0 | 0 | 1 |

A logic output relationship for the first latch module RS1 or the second latch module RS2 can be derived from the above truth table for the NOR gate (nor1, nor2 or nor3) in combination with FIG. 2, as shown in Table 2 below:

TABLE 2

| R | S | Q |
|---|---|---|
| 1 | 1 | 0 |
| 1 | 0 | 0 |
| 0 | 1 | X |
| 0 | 0 | 1 |

Here, when R=0 and S=1, the second input terminal IN2 of the third NOR gate nor3 satisfies IN2=1. From the truth table for the NOR gate, i.e., Table 1, it can be determined that the second input terminal IN2 of the second NOR gate nor2 satisfies IN2=0. On the other hand, when the first input terminal IN1 of the first NOR gate nor1 satisfies IN1=0 (i.e., R=0), the output terminal OUT of the first NOR gate nor1 (i.e., the output terminal Q of the first latch module RS1 or the second latch module RS2) is dependent on the previous state of the terminal NQ of the first latch module RS1 or the second latch module RS2.

In particular, in the previous state, the value outputted at the output terminal Q of the first latch module RS1 or the second latch module RS2 is X. That is, when R=0 and S=1, the value of Q remains the same as the previous state.

In accordance with the above logic output relationship for the first latch module RS1 or the second latch module RS2, the shift register unit (T1, T2, T3, T4, . . . , Tn) at each stage in the GOA circuit shown in FIG. 3 can invert and shift the pulse signal inputted at the pulse signal input terminal VIN, so as to obtain the scan signals (G1, G2, G3, G4, . . . , Gn) each having the same width as the pulse signal and shifted for each line, as shown in FIG. 4a or 4b.

The NOR gates according to this embodiment use N-type transistors and P-type transistors to constitute a complementary circuit. As shown in FIG. 5, when the N-type transistors (M3 and M4) are turned on, the P-type transistors (M1 and M2) are fully turned off. In this way, during the operating period of the NOR gate, none of the transistors is always on, so as to avoid the problem associated with high power consumption due to always-on transistors and high current leakage.

### Third Embodiment

As shown in FIG. 6, the first NOR gate nor1, the second NOR gate nor2, or the third NOR gate nor3 can include a fifth transistor M5, a sixth transistor M6 and a seventh transistor M7.

Here, the fifth transistor M5 has a gate connected to the first terminal IN1 of the NOR gate (nor1, nor2 or nor3), a first electrode connected to the output terminal OUT of the NOR gate (nor1, nor2 or nor3), and a second electrode connected to a second voltage terminal GNDA.

The sixth transistor M6 has a gate connected to the second input terminal IN2 of the NOR gate (nor1, nor2 or nor3), a first electrode connected to the first electrode of the fifth transistor M5, and a second electrode connected to the second voltage terminal GNDA.

The seventh transistor M7 has a gate and a first electrode both connected to a first voltage terminal VDDA, and a second electrode connected to the first electrode of the fifth transistor M5.

It is to be noted here that each of the fifth transistor M5, the sixth transistor M6 and the seventh transistor M7 is an N-type transistor.

Similarly to the principle of the third embodiment, a truth table for the NOR gate can be obtained by inputting a high level (1) or a low level (2) to the first input terminal IN1 and the second input terminal IN2 of the NOR gate (nor1, nor2 or nor3) as shown in FIG. 6, respectively. Here, the truth table for the NOR gate consisting of the fifth transistor M5, the sixth transistor M6 and the seventh transistor M7 according to this embodiment is the same as the truth table for the NOR gate according to the third embodiment, as shown in Table 1. In this case, the same logic output relationship for the first latch module RS1 or the second latch module RS2 can be derived, as shown in Table 2.

Similarly, in accordance with the above logic output relationship for the first latch module RS1 or the second latch module RS2, the scan signals (G1, G2, G3, G4, . . . , Gn) each having the same width as the pulse signal and shifted for each line can be obtained, as shown in FIG. 4a or 4b.

### Fourth Embodiment

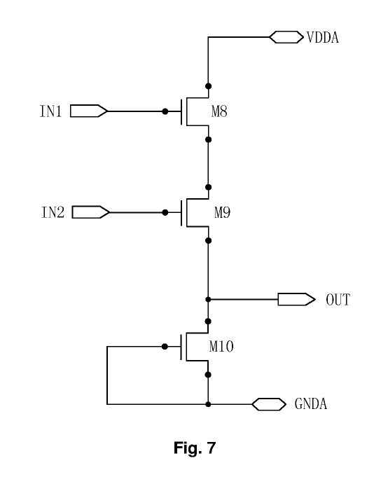

As shown in FIG. 7, the first NOR gate nor1, the second NOR gate nor2, or the third NOR gate nor3 can include an eighth transistor M8, a ninth transistor M9 and a tenth transistor M10.

The eighth transistor M8 has a gate connected to the first input terminal IN1 of the NOR gate (nor1, nor2 or nor3), a first electrode connected to a first voltage terminal VDDA, and a second electrode connected to a first electrode of the ninth transistor M9.

The ninth transistor M9 has a gate connected to the second input terminal IN2 of the NOR gate (nor1, nor2 or nor3), and a second electrode connected to the output terminal OUT of the NOR gate.

The tenth transistor M10 has a gate and a second electrode both connected to a second voltage terminal GNDA, and a first electrode connected to the second electrode of the ninth transistor M9.

It is to be noted here that each of the eighth transistor M8, the ninth transistor M9 and the tenth transistor M10 is a P-type transistor.

Similarly to the principle of the third embodiment, a truth table for the NOR gate can be obtained by inputting a high level (1) or a low level (2) to the first input terminal IN1 and the second input terminal IN2 of the NOR gate (nor1, nor2 or nor3) as shown in FIG. 6, respectively. Here, the truth table for the NOR gate consisting of the eighth transistor M8, the ninth transistor M9 and the tenth transistor M10 according to this embodiment is the same as the truth table for the NOR gate according to the third embodiment, as shown in Table 1. In this case, the same logic output relationship for the first latch module RS1 or the second latch module RS2 can be derived, as shown in Table 2.

Similarly, in accordance with the above logic output relationship for the first latch module RS1 or the second latch module RS2, the scan signals (G1, G2, G3, G4, . . . , Gn) each having the same width as the pulse signal and shifted for each line can be obtained, as shown in FIG. 4a or 4b.

In summary, compared with the second embodiment, the third and fourth embodiments use fewer transistors and thus have relatively simpler structures. However, as shown in FIG. 6, during the operating period of the NOR gate, the high level inputted at the first voltage terminal VDDA will keep the seventh transistor M7 on. Similarly, as shown in FIG. 7, the low level inputted at the second voltage terminal GNDA will keep the tenth transistor M10 on. Accordingly, the current leakage from the always-on seventh transistor M7 or tenth transistor M10 will increase the power consumption of the product. Therefore, the second embodiment is preferable.

According to an embodiment of the present disclosure, a display apparatus is provided. The display apparatus includes the above gate driving circuit and has the same advantageous effects as the gate driving circuit according to the above embodiments of the present disclosure. Details of the display apparatus will be omitted here since the gate driving circuit has been described in detail in connection with the above embodiments.

In particular, the display apparatus can be an LCD, an LCD TV, a digital frame, a mobile phone, a tablet computer, or another other LCD display product or component having a display function.

It can be appreciated by those skilled in the art that the all or part of the steps described in the above method embodiments can be implemented in hardware associated with program instructions. Such program can be stored in a computer readable storage medium and, when executed, perform the steps of the above method embodiments. Such storage medium can be a Read Only Memory (ROM), Random Access Memory (RAM), a magnetic disk, an optical disc, or any other mediums that can store program codes.

The present disclosure is not limited to the embodiments as described above. Any modifications or alternatives that can be made by those skilled in the art without departing from the spirit and principle of the present disclosure are to be encompassed by the scope of the present disclosure, which is defined only by the claims as attached.

1. A shift register unit, comprising:
a first latch module having a first input terminal connected to a first clock signal terminal or a second clock signal terminal, a second input terminal for receiving a pulse signal, and an output terminal; and
a second latch module having a first input terminal connected to the first clock signal terminal or the second clock signal terminal, a second input terminal connected to the output terminal of the first latch module, and an output terminal connected to a signal output terminal of the shift register unit,
wherein the first input terminal of the first latch module and the first input terminal of the second latch module are connected to the same signal terminal.

2. The shift register unit of claim 1, wherein at least one of the first latch module and the second latch module comprises a first NOR gate, a second NOR gate and a third NOR gate, wherein
the first NOR gate has a first input terminal for receiving the pulse signal, a second input terminal connected to an output terminal of the second NOR gate, and an output terminal connected to the output terminal of the first or second latch module,
the second NOR gate has a first input terminal connected to the output terminal of the first NOR gate, and a second input terminal connected to the output terminal of the third NOR gate, and
the third NOR gate has a first input terminal for receiving the pulse signal, and a second input terminal connected to the first or second clock signal terminal.

3. The shift register unit of claim 2, wherein the first, second or third NOR gate comprises: a first transistor, a second transistor, a third transistor and a fourth transistor, wherein
the first transistor has a gate connected to the first input terminal of the NOR gate, a first electrode connected to a first voltage terminal and a second electrode connected to a first electrode of the second transistor,
the second transistor has a gate connected to the second input terminal of the NOR gate and a second electrode connected to the output terminal of the NOR gate,
the third transistor has a gate connected to the gate of the second transistor, a first electrode connected to the second electrode of the second transistor, and a second electrode connected to a second voltage terminal, and
the fourth transistor has a gate connected to the gate of the first transistor, a first electrode connected to the second electrode of the second transistor, and a second electrode connected to the second voltage terminal.

4. The shift register unit of claim 3, wherein each of the first and second transistors is a P-type transistor, and each of the third and fourth transistors is an N-type transistor.

5. The shift register unit of claim 2, wherein the first, second or third NOR gate comprises: a fifth transistor, a sixth transistor and a seventh transistor, wherein
the fifth transistor has a gate connected to the first terminal of the NOR gate, a first electrode connected to the output terminal of the NOR gate, and a second electrode connected to the second voltage terminal,
the sixth transistor has a gate connected to the second input terminal of the NOR gate, a first electrode connected to the first electrode of the fifth transistor, and a second electrode connected to the second voltage terminal, and
the seventh transistor has a gate and a first electrode both connected to the first voltage terminal, and a second electrode connected to the first electrode of the fifth transistor.

6. The shift register unit of claim 5, wherein each of the fifth, sixth and seventh transistors is an N-type transistor.

7. The shift register unit of claim 2, wherein the first, second or third NOR gate comprises: an eighth transistor, a ninth transistor and a tenth transistor, wherein
the eighth transistor has a gate connected to the first input terminal of the NOR gate, a first electrode connected to the first voltage terminal, and a second electrode connected to a first electrode of the ninth transistor,
the ninth transistor has a gate connected to the second input terminal of the NOR gate, and a second electrode connected to the output terminal of the NOR gate, and
the tenth transistor has a gate and a second electrode both connected to the second voltage terminal, and a first electrode connected to the second electrode of the ninth transistor.

8. The shift register unit of claim 7, wherein each of the eighth, ninth and tenth transistors is a P-type transistor.

9. A gate driving circuit, comprising at least two stages of the shift register units according to claim 1, wherein
in the shift register unit at the first stage, the second input terminal of the first latch module is connected to a pulse signal input terminal,
in each of the shift register units except the one at the first stage, the second input terminal of the first latch module is connected to the signal output terminal of the shift register unit at the previous stage, and
in the shift register unit at each odd-numbered stage, the first input terminal of the first latch module and the first input terminal of the second latch module are connected to the first clock signal terminal, while in the shift register unit at each even-numbered stage, the first input terminal of the first latch module and the first input terminal of the second latch module are connected to the second clock signal terminal.

10. A display apparatus, comprising the gate driving circuit according to claim 9.

11. A gate driving circuit, comprising at least two stages of the shift register units according to claim 2, wherein:
in the shift register unit at the first stage, the second input terminal of the first latch module is connected to a pulse signal input terminal,
in each of the shift register units except the one at the first stage, the second input terminal of the first latch module is connected to the signal output terminal of the shift register unit at the previous stage, and
in the shift register unit at each odd-numbered stage, the first input terminal of the first latch module and the first input terminal of the second latch module are connected to the first clock signal terminal, while in the shift register unit at each even-numbered stage, the first input terminal of the first latch module and the first input terminal of the second latch module are connected to the second clock signal terminal.

12. A gate driving circuit, comprising at least two stages of the shift register units according to claim 3, wherein:
in the shift register unit at the first stage, the second input terminal of the first latch module is connected to a pulse signal input terminal,
in each of the shift register units except the one at the first stage, the second input terminal of the first latch module is connected to the signal output terminal of the shift register unit at the previous stage, and
in the shift register unit at each odd-numbered stage, the first input terminal of the first latch module and the first input terminal of the second latch module are connected to the first clock signal terminal, while in the shift register unit at each even-numbered stage, the first input terminal of the first latch module and the first input terminal of the second latch module are connected to the second clock signal terminal.

13. A gate driving circuit, comprising at least two stages of the shift register units according to claim 4, wherein:
in the shift register unit at the first stage, the second input terminal of the first latch module is connected to a pulse signal input terminal,
in each of the shift register units except the one at the first stage, the second input terminal of the first latch module is connected to the signal output terminal of the shift register unit at the previous stage, and
in the shift register unit at each odd-numbered stage, the first input terminal of the first latch module and the first input terminal of the second latch module are connected to the first clock signal terminal, while in the shift register unit at each even-numbered stage, the first input terminal of the first latch module and the first input terminal of the second latch module are connected to the second clock signal terminal.

14. A gate driving circuit, comprising at least two stages of the shift register units according to claim 5, wherein:
in the shift register unit at the first stage, the second input terminal of the first latch module is connected to a pulse signal input terminal,
in each of the shift register units except the one at the first stage, the second input terminal of the first latch module is connected to the signal output terminal of the shift register unit at the previous stage, and
in the shift register unit at each odd-numbered stage, the first input terminal of the first latch module and the first input terminal of the second latch module are connected to the first clock signal terminal, while in the shift register unit at each even-numbered stage, the first input terminal of the first latch module and the first input terminal of the second latch module are connected to the second clock signal terminal.

15. A gate driving circuit, comprising at least two stages of the shift register units according to claim 6, wherein:
in the shift register unit at the first stage, the second input terminal of the first latch module is connected to a pulse signal input terminal,
in each of the shift register units except the one at the first stage, the second input terminal of the first latch module is connected to the signal output terminal of the shift register unit at the previous stage, and
in the shift register unit at each odd-numbered stage, the first input terminal of the first latch module and the first input terminal of the second latch module are connected to the first clock signal terminal, while in the shift register unit at each even-numbered stage, the first input terminal of the first latch module and the first input terminal of the second latch module are connected to the second clock signal terminal.

16. A gate driving circuit, comprising at least two stages of the shift register units according to claim 7, wherein:
in the shift register unit at the first stage, the second input terminal of the first latch module is connected to a pulse signal input terminal,
in each of the shift register units except the one at the first stage, the second input terminal of the first latch module is connected to the signal output terminal of the shift register unit at the previous stage, and
in the shift register unit at each odd-numbered stage, the first input terminal of the first latch module and the first input terminal of the second latch module are connected to the first clock signal terminal, while in the shift register unit at each even-numbered stage, the first input terminal of the first latch module and the first input terminal of the second latch module are connected to the second clock signal terminal.

17. A gate driving circuit, comprising at least two stages of the shift register units according to claim 8, wherein:
in the shift register unit at the first stage, the second input terminal of the first latch module is connected to a pulse signal input terminal,
in each of the shift register units except the one at the first stage, the second input terminal of the first latch module is connected to the signal output terminal of the shift register unit at the previous stage, and
in the shift register unit at each odd-numbered stage, the first input terminal of the first latch module and the first input terminal of the second latch module are connected to the first clock signal terminal, while in the shift register unit at each even-numbered stage, the first input terminal of the first latch module and the first input terminal of the second latch module are connected to the second clock signal terminal.
